(19) United States
(12) Patent Application Publication
(10) Pub. No.: US 2006/0288303 A1
(43) Pub. Date: Dec. 21, 2006

(54) Portable electronic device and window control system

(75) Inventors: Hidenori Tachihara, Kodaira-shi (JP); Koji Kawakami, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/241,309

(22) Filed: Sep. 30, 2005

(30) Foreign Application Priority Data
May 12, 2005 (JP) 2005-139844

(51) Int. Cl. G06F 3/00

(52) U.S. Cl. 715/781

(57) ABSTRACT

A portable electronic device includes a controller configured to operate applications on at least two frameworks, a display configured to display windows of the applications, and a manager configured to manage a display order of windows to be displayed on the display. The manager inserts a dummy window between the windows of the applications operating on the two frameworks.

### CROSS-REFERENCE TO RELATED APPLICATIONS

This application is based upon and claims the benefit of priority from prior Japanese Patent Application No. 2005-139844, filed May 12, 2005, the entire contents of which are incorporated herein by reference.

### BACKGROUND OF THE INVENTION

1. Field of the Invention

The present invention relates to a portable electronic device.

2. Description of the Related Art

For example, various types of information are displayed on one screen while changing a display in a portable electronic device such as a portable phone. In this case, there is a portable electronic device in which two frameworks having different display systems are provided and an application independently operates in each framework to make predetermined display on the screen. Jpn. Pat. Appln. KOKAI Publication No. 2004-310655 discloses a control method for controlling a window for displaying several applications operating on one framework while changing several windows in this portable electronic device. This control method is a window stack control method for managing stacked windows in displaying a plurality of windows in a display unit, in which windows are grouped for each application and display is controlled for each window group. This window stack control method controls window stack of applications operating on a single framework. Thus, if one wants to cause applications operating on several frameworks to operate on a single system, window stack between frameworks is not synchronized. Consequently there is a problem that framework conflict cannot be controlled, such as “one framework is not displayed on a window stack displayed using the other framework.”

That is, since an application operating on each framework independently operates without mutual association, applications operating on different frameworks perform the respective display processings without mutually recognizing that other application is operating. Therefore, there is a problem that an unintentional screen (i.e., window) is displayed at an unintentional time, for example, a pop-up screen for e-mail reception is displayed during call.

### BRIEF SUMMARY OF THE INVENTION

The present invention provides a technique in which window display by an application operating on one framework in a portable electronic device does not influence a display in other framework.

In the present invention, a difference in the window stack control methods between frameworks is absorbed in an integration layer belonging below the framework, and window stack control unique to the system is further performed in the integration layer so that display control is performed without causing mutual frameworks to recognize the window stack. Dummy windows and proxy tasks are used as means therefor.

A portable electronic device according to the present invention is characterized by comprising a controller configured to operate applications on at least two frameworks; a display configured to display windows of the applications; and a manager configured to manage a display order of windows to be displayed on the display, wherein the manager inserts a dummy window between the windows of the applications operating on the two frameworks.

The present invention can be achieved by not only the above system or apparatus but also a method or program for realizing the functions in the system or apparatus.

### BRIEF DESCRIPTION OF THE SEVERAL VIEWS OF THE DRAWING

FIG. 1 is a perspective view of an appearance of a portable electronic device to which a window control system according to an embodiment of the present invention is applied;

FIG. 2 is a block diagram showing a circuit configuration of the portable electronic device shown in FIG. 1;

FIG. 3 is a diagram showing a structure of an application or the like in a memory;

FIGS. 4A and 4B are diagrams for explaining a case of permitting interrupt display;

FIG. 5 is a diagram showing an example of window stack according to FIGS. 4A and 4B;

FIG. 6 is a diagram showing a flow of operation when permitting interrupt display;

FIG. 7 is a diagram showing an example of window stack in step A2;

FIG. 8 is a diagram showing an example of window stack in step A3;

FIG. 9 is a diagram showing an example of window stack in step A4;

FIGS. 10A to 10C are diagrams for explaining a case of not permitting interrupt display;

FIG. 11 is a diagram showing an example of window stack according to FIG. 10;

FIG. 12 is a diagram showing a flow of operation when not permitting interrupt display; and

FIG. 13 is a diagram showing an example of window stack in step B2.

### DETAILED DESCRIPTION OF THE INVENTION

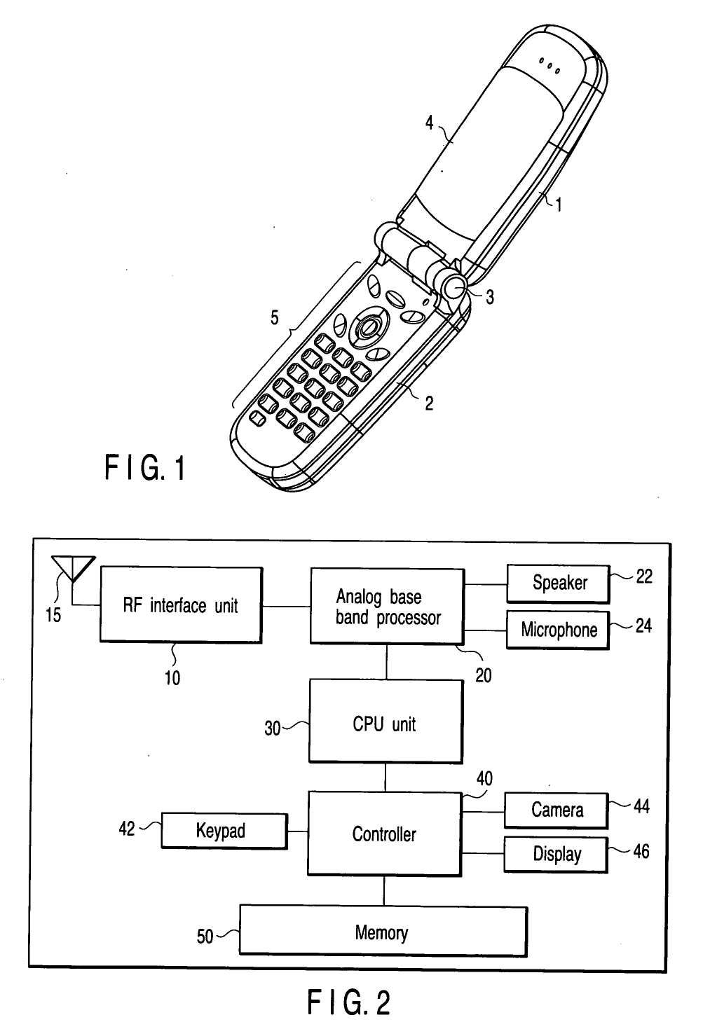

An embodiment according to the present invention will be described below with reference to the drawings. FIG. 1 is a perspective view showing an appearance of a portable electronic device to which a window control system according to the embodiment of the present invention is applied. This portable electronic device is a so-called foldable portable communication terminal in which an upper portion 1 and a lower portion 2 are rotatably connected through a hinge mechanism 3, and FIG. 1 shows a state where each portion 1, 2 is opened.

The upper portion 1 is arranged with a main LCD (Liquid Crystal Display) 4 at its front and a sub-LCD (Liquid Crystal Display) (not shown) at its back. On the other hand, the lower portion 2 incorporates therein a main printed wiring board (not shown), a key input device 5 and the like.

FIG. 2 is a block diagram showing a circuit configuration of the portable electronic device shown in FIG. 1.

The portable electronic device shown in FIG. 2 comprises a RF interface 10 connected to an antenna 15, an analog base band processor 20, a CPU 30, a controller 40 and a memory 50.

The antenna 15 performs transmission/reception of wireless signals.

The RF interface 10 performs reception processing of wireless signals received in the antenna 15 or transmission processing for transmitting wireless signals from the antenna 15.

The analog base band processor 20 is connected with a speaker 22 and a microphone 24. The analog base band processor 20 outputs an voice signal input from the speaker 22 to the RF interface 10 through encode processing or protocol control, or outputs an voice signal to the microphone 24 through decode processing or protocol control of a wireless signal input from the RF interface 10. Further, the analog base band processor 20 performs encode processing or decode processing of data such as an image input through the CPU 30.

The CPU 30 performs all the computation processings and controls the entire device.

The controller 40 controls peripheral devices such as a keypad 42 for inputting characters or numerals, a camera 44 for photographing a still image or moving image, a display 46 for displaying various information such as image or list, and the memory 50 for storing therein program or data such as application or middleware.

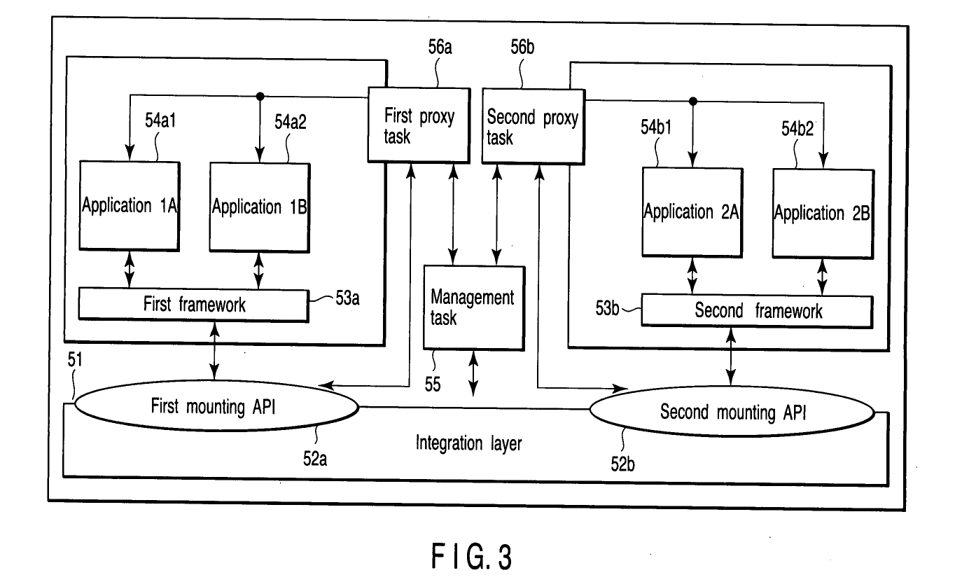

In the embodiment according to the present invention, a difference in the control method for display between different frameworks is absorbed. A structure of application or the like in the memory is shown in FIG. 3.

Typically, when there are two frameworks, the memory stores therein a first framework 53a and a second framework 53b. An application 1A 54a1, an application 1B 54a2, and an application 2A 54b1, an application 2B 54b2 operate on the first framework 53a and the second framework 53b, respectively. In the present embodiment, in order to absorb a difference in control between the first framework 53a and the second framework 53b, there is provided an integration layer 51 which belongs below the first and second frameworks 53a and 53b. The integration layer 51 provides a mechanism for mounting the first and second frameworks 53a and 53b. A specific structure thereof will be described below.

As shown in FIG. 3, the integration layer 51 is provided with a first mounting API (Application Program Interface) 52a and a second mounting API 52b. The first mounting API 52a provides the function required for mounting the first framework 53a, and the second mounting API 52b provides the function required for mounting the second framework 53b. Applications 54a1 to 54b2 are programs for providing a user with the functions of the portable electronic device, which operate on the frameworks 53a and 53b, respectively. The first and second frameworks 53a and 53b are a mass of parts (library and the like) required for mounting each application, each of which has a different window system.

A management task 55 is a program for performing management such as a status management or conflict management of each application 54a1 to 54b2. However, since the applications 54a1 to 54b2 operating on the first and second frameworks 53a and 53b are different in the control method for each framework, they cannot be directly controlled by this management task 55. Thus, there are provided proxy tasks for exchanging between each application 54a1 to 54b2 and the management task 55. Specifically, there are provided a first proxy task 56a for exchanging between the applications 54a1, 54a2 and the management task 55, and a second proxy task 56b for exchanging between the applications 54b1, 54b2 and the management task 55.

With the above structure, the applications 54a1, 54a2, and 54b1, 54b2, which are independently managed for each framework 53a, 53b, can be collectively managed in the management task 55.

In the portable electronic device as constructed above, there will be shown a control example where when a window of one framework is displayed on the front, interrupt display occurs by other framework.

At first, a case of permitting interrupt display will be described.

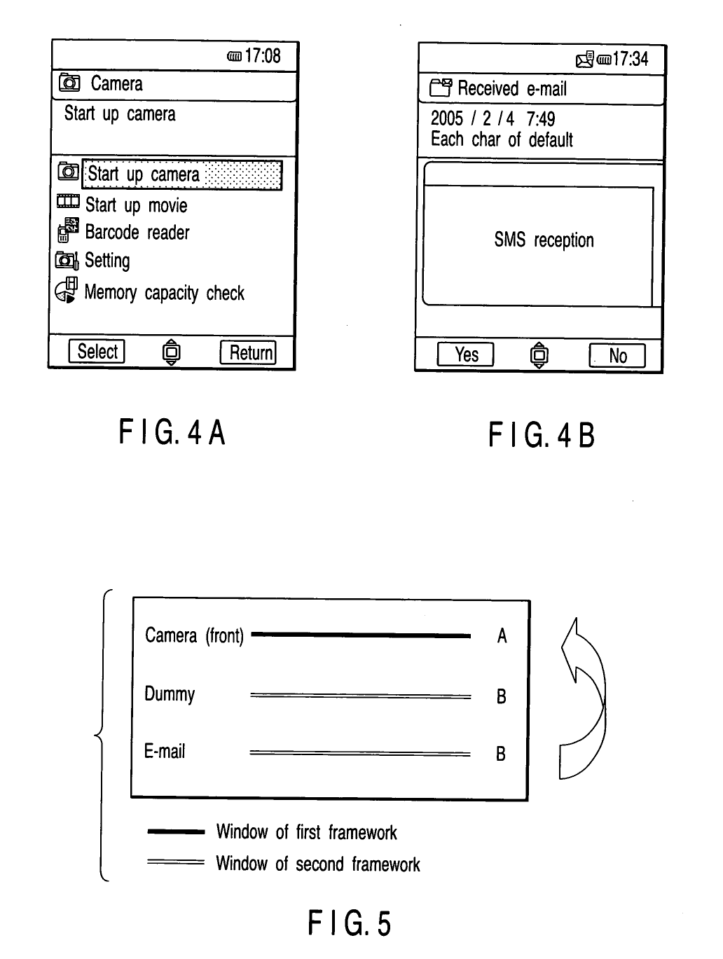

It is assumed that windows as shown in FIGS. 4A and 4B are present together, a window of a camera application of FIG. 4A is present at the front, and a window of an e-mail application of FIG. 4B is present therebelow and is hidden. A window stack at this time is shown in FIG. 5. In FIG. 5, “A” represents a window of the first framework and “B” represents a window of the second framework. As shown in FIG. 5, in the embodiment according to the present invention, a dummy window is added, which causes the management task 55 to recognize that the application (camera) in other framework is present on the application (e-mail) in the second framework. Thus, it is possible to control display/hide on the actual screen while causing each application to recognize that it is displaying a window of each application. The actual control method will be described later.

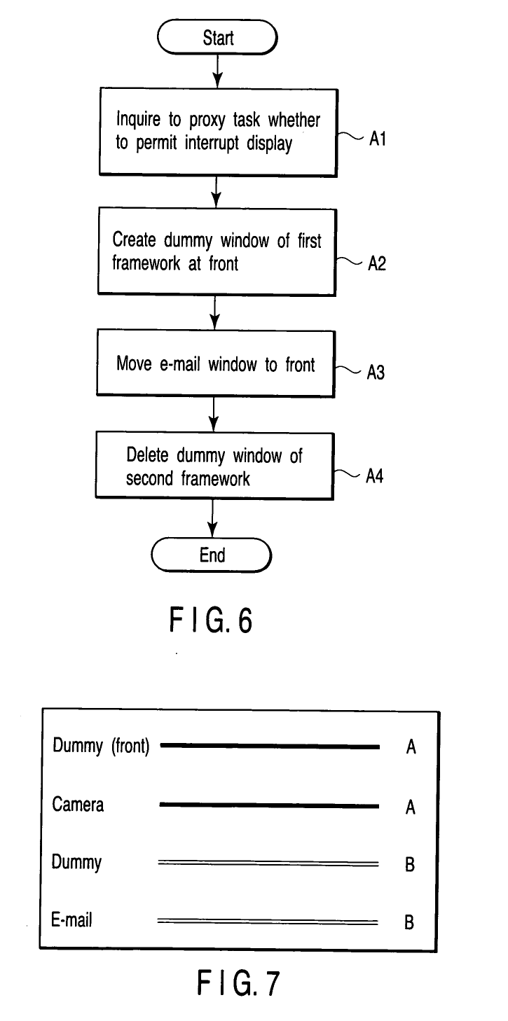

A flow of operation when permitting interrupt display will be described with reference to FIGS. 6 to 9. FIG. 6 is a diagram showing a flow of operation when permitting interrupt display, and FIGS. 7 to 9 are diagrams each showing an example of window stack in each step. The operation of FIG. 6 is an example where when a window of the camera application (first framework) (hereinafter, referred to as “camera window”) is displayed, a window of the e-mail application (second framework) (hereinafter, referred to as “e-mail window”) is interrupt-displayed.

At first, when an interrupt request of the e-mail window is made, an inquiry whether to perform interrupt display is made to the proxy task 56a (or 56b) (step Al). Here, when the management task 55 determines to permit the interrupt display, the interrupt display is performed through the operation from steps A2 to A4.

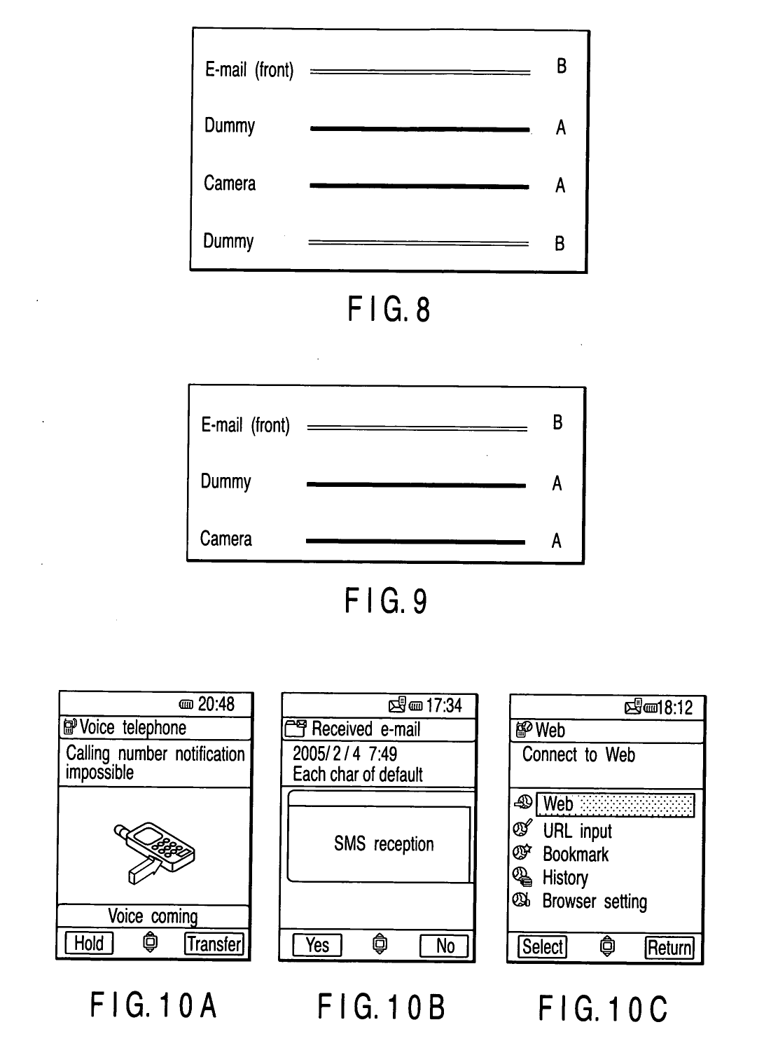

Specifically, a dummy window of the first framework is created on the front (step A2, FIG. 7). Thereby, a dummy window is created for the first framework and the second framework, respectively. Next, the e-mail window is moved to the front (step A3, FIG. 8). At this time, the e-mail window is in the displayed state, and the camera window moves immediately below the dummy window. At this time, the dummy window of the second framework is not necessary and is deleted (step A4, FIG. 9).

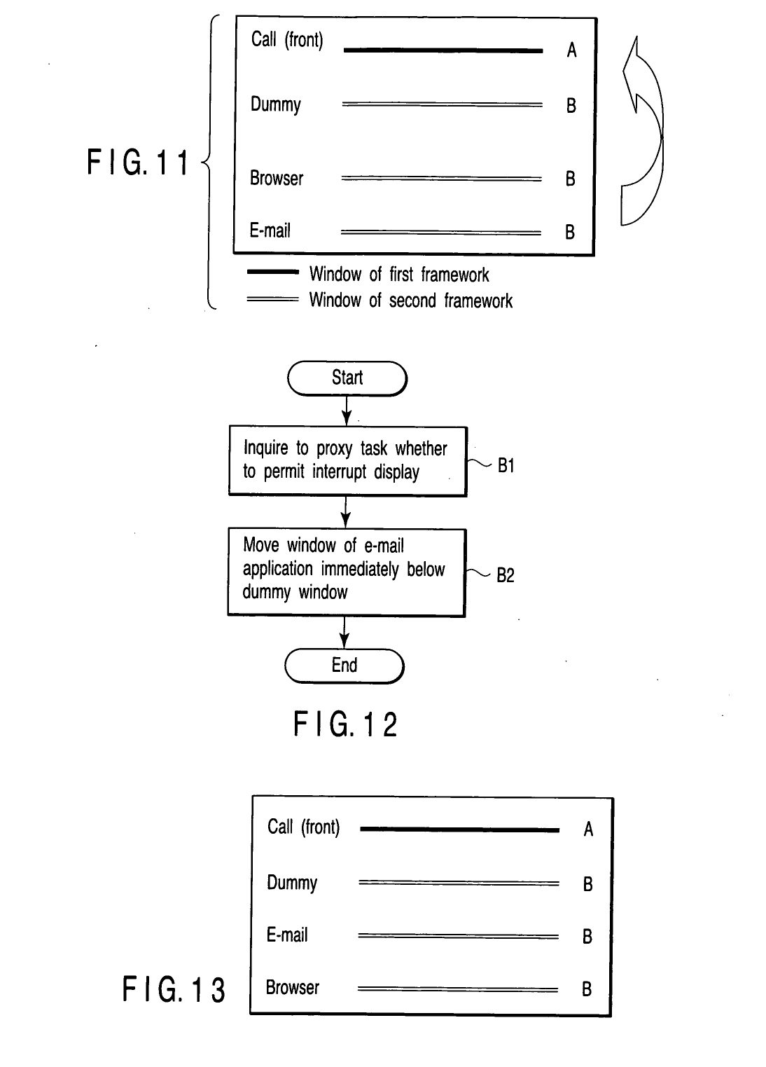

A flow of operation when not permitting interrupt display will be described with reference to FIGS. 10 to 12. FIG. 11 shows a window stack in the initial state of the window of FIG. 10. FIG. 12 is a diagram for explaining a flow of operation when not permitting interrupt display, and FIG. 13 is a diagram showing an example of window stack in step B2 of FIG. 12.

As shown in FIGS. 10A to 10C, it is assumed that a call window (FIG. 10A), an e-mail window (FIG. 10B) and a window of a browser application (second framework) (FIG. 10B, hereinafter, referred to as “browser window”) are present, the call window is present at the front as shown in FIG. 11, and the dummy window, the browser window and the e-mail window are arranged in this order.

In this case, when an interrupt request of the e-mail window is made, an inquiry whether to perform interrupt display is made to the proxy task 56a (or 56b) (step Bl). When the display in the call window represents calling, the interrupt is not preferable. Thus, the management task 55 determines not to permit interrupt display, and the e-mail window for displaying e-mail reception when the call is terminated is moved immediately below the dummy window (step B2, FIG. 13). Specifically, although the call window is present at the front at this time, the e-mail window and the browser window have been exchanged, and the window to be displayed when the call is terminated is not the browser window but the e-mail window.

When the call is terminated, the call widow enters the interrupt-permitted state, and the window is terminated or is arranged immediately below the browser via the dummy window. When the dummy window arranged between the call window and the e-mail window is erased, the e-mail window is displayed at the front.

In the portable electronic device according to the present invention, when an event of key pressing by the keypad 42 occurs, a keyboard focus is controlled to be placed on the uppermost window in the first framework and the uppermost window in the second framework. Thus, when the dummy window of the same framework is further present on the respective uppermost frameworks, the keyboard focus is placed on the dummy window.

For example, in the example of window stack shown in FIG. 13, the keyboard focus of the first framework is placed on the call window and the keyboard focus of the second framework is placed on the dummy window. Thus, when the key is pressed by the keypad 42, the event of key inputting is notified to the call window and the dummy window. Thereby, distribution of the key pressing event for the application on the framework having the dummy window can be prevented.

As described above, in the embodiment according to the present invention, the dummy window is introduced. so that the display of the windows of the applications operating on the respective frameworks can be collectively managed in the management task. Therefore, it is possible to prevent unintentional display. When a display request from an application which is not recognized (managed) by the management task is made, it is all prevented so that unintentional display is not performed.

According to the present invention, it is possible to absorb a difference in design concept between applications having different display systems and to place the applications on one single platform together.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A portable electronic device comprising:
a controller configured to operate applications on at least two frameworks;
a display configured to display windows of the applications; and
a manager configured to manage a display order of windows to be displayed on the display,
wherein the manager configured to insert a dummy window between the windows of the applications operating on the two frameworks.

2. The portable electronic device according to claim 1, further comprising a management task configured to control permission or prohibition of interrupt display of the application, if a window of a first application of the applications operating on a first framework of the two is displayed at the front, a window of a second application of the applications operating on a second framework of the two is not displayed at the front window, and the interrupt display of the second application is requested by the controller.

3. The portable electronic device according to claim 2, wherein the management task configured to insert a dummy window of the first framework at the front and then move the window of the second framework to the front, If the interrupt display is permitted, and
if the interrupt display is prohibited, the management task configured to move the window to be subjected to the interrupt display below the dummy window of the second framework.
